(19) United States
(12) Patent Application Publication
(10) Pub. No.: US 2021/0155725 A1
(43) Pub. Date: May 27, 2021

(54) METHOD FOR PREPARING POLYVINYLBUTYRAL RESIN COMPOSITION, AND GLASS- ADHESIVE FILM COMPRISING SAME

(71) Applicant: SKC Co., Ltd., Suwon-si (KR)

(72) Inventors: Hyejin KIM, Suwon-si (KR); Jiyeon RYU, Suwon-si (KR); Jooyoung JUNG, Pyeongtaek-si (KR); Haksoo LEE, Suwon-si (KR)

(73) Assignee: SKC Co., Ltd., Suwon-si (KR)

(21) Appl. No.: 17/167,389

(22) Filed: Feb. 4, 2021

Related U.S. Application Data
(63) Continuation of application No. PCT/KR2019/002690, filed on Mar. 8, 2019.

(30) Foreign Application Priority Data
Aug. 16, 2018 (KR) 10-2018-0095765

(51) Int. Cl. C08F 8/28; C08F 116/38; C08K 5/06; C08K 5/09; B32B 27/08; B32B 27/22; B32B 27/30; B32B 17/10

(52) U.S. Cl. CPC C08F 8/28; B32B 2605/08; C08K 5/06; C08K 5/09; B32B 27/08; B32B 27/22; B32B 27/306; B32B 17/10036; B32B 17/10605; B32B 17/10761; C08F 2800/20; B32B 2250/03; B32B 2250/05; B32B 2307/412; B32B 2315/08; B32B 2605/006; C08F 116/38

(57) ABSTRACT

A method of producing a polyvinyl butyral resin composition including: preparing a reaction composition including i) a polyvinyl alcohol resin, ii) a butanal, and iii) a butanoic acid; and obtaining the polyvinyl butyral resin composition, wherein a conversion rate of butanal is 77% or more.

### CROSS-REFERENCE TO RELATED APPLICATIONS

Pursuant to 35 USC 120 and 365(c), this application is a continuation of International Application No. PCT/KR2019/002690 filed on Mar. 8, 2019, and claims the benefit under 35 USC 119(a) of Korean Application No. 10-2018-0095765 filed on Aug. 16, 2018, in the Korean Intellectual Property Office, the entire disclosures of which are incorporated herein by reference for all purposes.

### BACKGROUND

### 1. Field

The present disclosure relates to a method of producing a polyvinyl butyral resin composition and a film for glass lamination including the polyvinyl butyral resin composition.

### 2. Description of the Background

In general, laminated glass (e.g., tempered glass and safety glass) consisting of a pair of glass panels and a synthetic resin film inserted therebetween is widely used for a window glass in road vehicles such as automobiles because of its enhanced safety, due to the fact that fragments of laminated glass are not scattered even when the laminated glass is broken. In some cases, a polyvinyl acetal resin having a high affinity for inorganic materials is utilized in the film applied to such laminated glass.

A polyvinyl acetal resin is manufactured by a method such as advancing acetalization reaction of a polyvinyl alcohol and an aldehyde. In commercial processes, for improving production efficiency of the polyvinyl acetal resin, material is often added in excess against the number of reacting moles, and unintended side reaction products caused from such material added in an excessive amount may be formed. And such side reaction products affect the color, durability and so on of a synthetic resin film. Accordingly, eliminating such side reaction products effectively is important. Japanese Patent Registration No.5588091 discloses a process of treating resin slurry with heat, and Japanese Patent Registration No.5926602 discloses a method of advancing acetalization reaction under the condition of high temperature and high pressure with a predetermined hydrogen ion concentration of an acid catalyst.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of producing a polyvinyl butyral resin composition includes: preparing a reaction composition including i) a polyvinyl alcohol resin, ii) a butanal, and iii) a butanoic acid; and obtaining the polyvinyl butyral resin composition, wherein a conversion rate of butanal is 77% or more, and wherein the conversion rate of butanal is calculated according to Formula 1:

conversion rate of butanal (mole %)=actual mole number of butyral groups in the polyvinyl butyral resin/stoichiometric mole number of butyral groups in the polyvinyl butyral resin when all of the butanal in the reaction composition is reacted*100. (1)

The polyvinyl butyral resin in the polyvinyl butyral resin composition may be formed by an acetalization reaction of the reaction composition.

The preparing the reaction composition may include preparing a polyvinyl alcohol resin solution and adding the butanal and the butanoic acid to the polyvinyl alcohol solution.

The reaction composition may include the butanoic acid in an amount of 0.1 to 5 parts by weight based on the butanal in an amount of 10 parts by weight in the reaction composition.

The polyvinyl butyral resin composition may include the residual butanal in an amount of 17 mol % or less based on the butanal included in the reaction composition.

The method may further include: neutralizing the polyvinyl butyral resin composition; washing the neutralized polyvinyl butyral resin composition one or more times; and drying the washed polyvinyl butyral resin composition.

The washing may be performed with a washing solution having a weight ratio of 5 to 10 with respect to a weight of the polyvinyl butyral resin in the polyvinyl butyral resin composition.

The polyvinyl butyral resin composition after the washing may include the residual butanoic acid in an amount of 0.01 wt % or less based on a total weight of the polyvinyl butyral resin composition.

The method may decrease an amount of an unreacted butanal by 5 mol % or more compared to a method of producing polyvinyl butyral resin composition using a reaction composition not including a butanoic acid.

In another general aspect, a film for lamination includes: a lamination layer including i) a polyvinyl butyral resin composition including a polyvinyl butyral resin, a butanoic acid, and 2-ethylhexanoic acid; and ii) a plasticizer.

An amount of the butanoic acid in the lamination layer is more than 0 ppm, and 70 ppm or less based on a total weight of the lamination layer.

An amount of the 2-ethylhexanoic acid in the lamination layer may be more than 0 ppm, and 70 ppm or less based on a total weight of the lamination layer.

The lamination layer may have a yellow index of 2.7 or less.

The polyvinyl butyral resin in the polyvinyl butyral resin composition may be formed by an acetalization reaction of the reaction composition including a polyvinyl acetal resin, a butanal, and a butanoic acid.

The film for lamination may include: a first layer including a first polyvinyl acetal and a first plasticizer; a second layer including a second polyvinyl acetal and a second plasticizer and disposed on the first layer; and a third layer including a third polyvinyl acetal and a third plasticizer and disposed between the first layer and the second layer.

The first layer may include the first polyvinyl acetal in an amount of 60 to 75 parts by weight and the first plasticizer in an amount of 25 to 40 parts by weight, based on a total weight of the first layer.

The second layer may include the second polyvinyl acetal in an amount of 60 to 75 parts by weight and the second plasticizer in an amount of 25 to 40 parts by weight, based on a total weight of the second layer.

The third layer may include the third polyvinyl acetal in an amount of 58 to 69 parts by weight and the third plasticizer in an amount of 31 to 42 parts by weight, based on a total weight of the third layer.

An amount of a third hydroxyl group in the third polyvinyl acetal is lower than an amount of a first hydroxyl group in the first polyvinyl acetal or an amount of a second hydroxyl group in the second polyvinyl acetal.

In another general aspect, a laminated glass includes a laminate including: a first glass; the film for lamination described above; and a second glass, wherein the first glass is disposed on one side of the film and the second glass is disposed on the other side of the film.

Other features and aspects will be apparent from the following detailed description and the claims.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

In the present specification, terms of degree such as “about” and “substantially” are used to mean values approximately equal to a value when a tolerance to be proper to referred meaning for manufacture and substance is presented. Additionally, these terms of degree are used to help understanding of examples and to cover examples that differ insignificantly from an exact or absolute number.

In the present specification, the term “combination of” included in Markush type description means mixtures or combinations of one or more elements described in Markush type and thereby means that the disclosure includes one or more elements selected from the Markush group.

In the present specification, the description of “A and/or B” means “A, or B, or A and B.”

In the present specification, the terms such as “first”, “second” or “A”, “B” are used to distinguish the same terms from each other, unless specifically stated otherwise.

In the present specification, it will be understood that when “B” is referred to as being on “A”, “B” can be directly on “A” or intervening other component(s) may be present therebetween. That is, the location of “B” is not construed as being limited to direct contact of “B” with the surface of “A”.

In the present specification, the singular forms “a” “an” and “the” are intended to include the plural forms as well, unless context clearly indicates otherwise.

In the present specification, ppm, the unit expressing the amount is based on weight.

The method of producing a polyvinyl butyral resin composition and a film for glass lamination including the polyvinyl butyral resin composition can produce a polyvinyl butyral resin composition in which yellowing does not substantially occur and durability is enhanced, by preventing reaction residues and occurrence of side reaction, and can provide a film for glass lamination including the polyvinyl butyral resin composition.

The inventors had conducted research to decrease yellowing of a film including polyvinyl butyral resin and to enhance durability of the film. The inventors verified that acidic substance in a trace amount in the film affects yellowing occurrence and weakens durability of the film in an extruding process, which proceeds in a relatively high temperature. Therefore, the inventors identified such acidic substance in the film, and completed the method of producing a polyvinyl butyral resin composition, which can reduce the acidic substance.

The method of producing the polyvinyl butyral resin composition according to one or more example embodiments includes: preparing a reaction composition including i) a polyvinyl alcohol resin, ii) a butanal, and iii) a butanoic acid; and obtaining the polyvinyl butyral resin composition. The polyvinyl butyral resin composition may include i) a polyvinyl butyral resin, ii) a residual butanoic acid, and iii) a residual butanal.

The polyvinyl butyral resin in the polyvinyl butyral resin composition may be formed by an acetalization reaction of the reaction composition.

The method improves reaction efficiency, lowering the amount of the residual butanal in the polyvinyl butyral resin composition obtained. When the reaction composition is applied to manufacture of a film including a polyvinyl butyral resin, an oxidation reaction is prevented due to the presence of the butanoic acid. Also, the resulting film prepared using the polyvinyl butyral resin composition having decreased amount of 2-ethylhexanoic acid, which is one of reaction by-products derived from butanal and considered as causing yellowing inside the film, can be produced.

The conversion rate of the butanal according to the method may be 77% or more, of 78% or more, of 78 to 90%, or of 82 to 90%.

The above range is a considerably high for a conversion rate of butanal, and when such a polyvinyl butyral resin composition is applied to manufacture a film, generation of reaction by-products derived from the residual butanal can be prevented. Also, a polyvinyl butyral resin having a more excellent quality and a film for lamination manufactured from the polyvinyl butyral resin can be produced.

The conversion rate of butanal, may be calculated from the amount of butanal based on mole or weight. For example, the conversion rate of butanal is calculated from the ratio of the actual amount of butyral groups (mol) in the polyvinyl butyral resin (acetalization degree) prepared, based on the stoichiometric amount of butyral groups (mol) which can be contained in the polyvinyl butyral resin when 100% of the butanals are reacted, and the ratio is expressed as %.

After the conversion of the butanal included in the reaction composition, the polyvinyl butyral resin composition may include the residual butanal in an amount of 17 mol % or less based on the butanal included in the reaction composition. For example, the polyvinyl butyral resin composition may have the residual butanal in an amount of 17 mol % or less, of 10 to 17 mol %, or of 10 to 13 mol % based on the butanal included in the reaction composition, i.e., the total amount of butanal group comprised in the polyvinyl butyral resin and the residual butanal.

In commercial processes of synthesizing polyvinyl acetals represented by polyvinyl butyral, for production efficiency, an excessive amount, rather than a stoichiometric number of moles of an aldehyde such as butanal is added. Accordingly, a residual aldehyde such as butanal is generated, and the residual aldehyde generates aldehyde-derived reaction products through processes such as aldol condensation reaction, reduction, oxidation, and so on.

Among these aldehyde-derived reaction products, particularly acidic materials such as 2-ethylhexanoic acid, which is generated when butanal is used, are harmful to environment, and may induce yellowing or degraded durability of the polyvinyl acetal film manufactured using the same. Particularly, due to a property of a polyvinyl butyral resin, whose decomposition is easily accelerated by an acid, yellowing of the film may occur easily and durability of the film may be adversely affected, especially where a film for lamination is processed in relatively high temperature.

To address these problems, it is essential to reduce the amount of the residual aldehyde after acetalization reaction.

In an ideal situation, all the aldehyde included in the reaction composition are converted to polyvinyl acetal. However, such an ideal situation is practically difficult. Instead, an additional oxidation reaction of the aldehyde may occur by water and the like generated from dehydration reaction of the polyvinyl alcohol, when the polyvinyl alcohol coexists with the aldehyde.

For example, in an acetalization reaction of a polyvinyl alcohol and a butanal, by-products may be generated by an oxidation reaction of the butanal, thereby the amount of butanal, which should be applied to synthesize a polyvinyl butyral, may decrease, and the conversion rate of the butanal may be lowered. Additionally, the amount of vinyl alcohol group, which should be converted to a polyvinyl butyral, may decrease by dehydration reaction of a polyvinyl alcohol, such that the conversion rate of polyvinyl alcohol to polyvinyl butyral may also decrease.

Therefore, in the present disclosure, the reaction composition may include a butanoic acid, to prevent the oxidation reaction of butanal, which is one cause of lowering conversion rate of butanal in the process of synthesizing the polyvinyl butyral.

The reaction composition may include the butanoic acid (C₃H₇COOH) in an amount of 0.1 to 5 parts by weight based on the butanal (butyraldehyde, C₄H₈O) in an amount of 10 parts by weight. Also, the reaction composition may include the butanoic acid in an amount of 0.1 to 3 parts by weight based on the butanal in an amount of 10 parts by weight. When the reaction composition includes a butanoic acid in such ranges, preventing oxidation reaction of butanal and enhancing the conversion rate to polyvinyl butyral can be effectively achieved. This eventually decreases the amount of the residual butanal in the polyvinyl butyral resin composition, and decreases the amount of reaction by-products derived from butanal, particularly acidic reaction products in a film for lamination manufactured thereafter.

The polyvinyl butyral resin composition may comprise a butanoic acid in an amount of 0.01 wt % or less, of more than 0 wt % and 0.01 wt % or less, or of 0.0001 wt % to 0.01 wt %, based on a total weight of the polyvinyl butyral resin composition.

The butanoic acid may increase the conversion rate of butanal in acetalization reaction. After the acetalization reaction, it is preferrable to eliminate the butanoic acid from the resulting polyvinyl butyral resin composition. The butanoic acid is water-soluble, thus after the acetalization reaction, it may be eliminated by a process of washing in water and the like. Accordingly, the butanoic acid is eliminated after the acetalization reaction, such that it may be included in the resulting polyvinyl butyral composition in a considerably trace amount.

Except that the reaction composition includes a butanoic acid, conventional reaction compositions and methods for preparing a polyvinyl butyral resin composition are applicable.

For example, the polyvinyl alcohol may have a polymerization degree of 1,600 to 3,000, or of 1,700 to 2,500. When such a polyvinyl alcohol is applied, a polyvinyl butyral resin for film manufacture, of which mechanical properties such as a penetration resistance are excellent, may be obtained.

The polyvinyl butyral may be produced by acetalization reaction of the polyvinyl alcohol and the butanal. The acetalization reaction may proceed under a catalyst, and the catalyst may be an acidic catalyst. For example, hydrochloric acid, sulfuric acid, nitric acid may be used, and preferably nitric acid may be used, but the catalyst is not limited thereto.

The butanal may be a n-butyl aldehyde. When a n-butyl aldehyde is used, the resulting polyvinyl butyral resin may have a refractive index that has a small difference with a refractive index of glass, and may have an excellent adhesion with glass and the like.

The amount of butyral group and hydroxyl group in the resulting polyvinyl butyral resin may be adjusted depending on mole ratio of the polyvinyl alcohol resin and the butanal in the reaction composition. For example, two hydroxyl groups in the polyvinyl alcohol resin and one butanal are combined to form a butyral group. Accordingly, the number of moles of the butanal included in the reaction composition may be adjusted considering the number of moles of vinyl alcohol in the polyvinyl alcohol resin and a targeted butyralation degree (a butyralation degree after the reaction).

The polyvinyl butyral resin synthesized in this manner may have hydroxyl group in an amount of 30 mol % or more, and acetyl group in an amount of 3 mol % or less. Specifically, the amount of the hydroxyl group may be 30 to 50 mol %, and the amount of the acetyl group may be 2 mol % or less. In addition, the value of weight average molecular quantity may be 200,000 to 300,000. When a polyvinyl butyral resin having these characteristics is applied, a film for lamination, which has excellent adhesion with glass and the like, and excellent mechanical strength, can be manufactured.

The polyvinyl butyral resin synthesized in this manner may have hydroxyl group in an amount of 40 mol % or less, and acetyl group in an amount of 3 mol % or more. Specifically, the polyvinyl butyral resin may have hydroxyl group in an amount of 5 to 30 mol % and acetyl group in an amount of 3 to 20 mol %. When a polyvinyl butyral resin having these characteristics is applied, a polyvinyl butyral resin film having a sound insulation quality can be manufactured.

The method of producing the polyvinyl butyral resin may have a neutralization step, a washing step, and a drying step in order. The detailed content of each step is not limited specially, and conventional methods applied to manufacture of a polyvinyl butyral resin can be utilized.

A base may be used in the neutralization step. Bases conventionally used in a neutralization reaction may be used, and for example, it may be a sodium hydroxide, but not limited thereto.

The washing step includes applying a washing solution to the polyvinyl butyral resin composition after the reaction step or the neutralization step.

For example, the washing step may be performed one or more times using a washing solution having weight ratio of 1 to 20 with respect to the weight of the polyvinyl butyral resin in the polyvinyl butyral resin composition. The washing step may be performed one or more times using a washing solution having weight ratio of 5 to 10 with respect to the weight of the polyvinyl butyral resin in the polyvinyl butyral resin composition, and may be performed five times or more.

The washing solution may be distilled water and the like, but solutions that can be used for washing are applicable without limit.

The method may decrease an amount of an unreacted butanal by 5 mol % or more compared to a method of producing polyvinyl butyral resin composition using a reaction composition not including a butanoic acid.

When the polyvinyl butyral resin composition prepared by the method described above is included in a lamination layer in a film for lamination, an amount of 2-ethylhexanoic acid in the lamination layer may be more than 0 ppm and 70 ppm or less.

Among by-products derived from the butanal (Formula 1 below), 2-ethylhexanoic acid (Formula 2 below) is an acidic substance, and is thought to be a substance affecting yellowing index and durability of a film manufactured using a polyvinyl butyral resin composition.

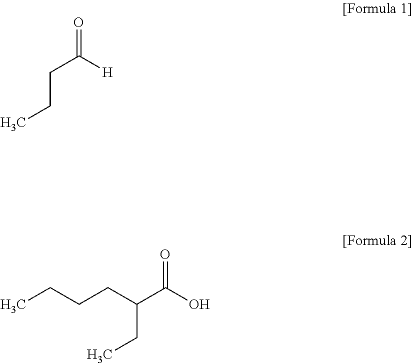

The method of the present disclosure may lower the amount of the residual butanal included in the resulting polyvinyl butyral resin composition, and may also lower the amount of 2-ethylhexanoic acid, which is derived from the residual butanal and generates yellowing or weakening of durability during manufacture of a film.

The polyvinyl butyral resin composition according to one or more other example embodiments of the present disclosure includes: i) a polyvinyl butyral resin derived from an acetalization reaction between a polyvinyl alcohol resin and a butanal in the presence of a butanoic acid, and ii) a residual butanal, wherein a conversion rate of the butanal is 77% or more and the amount of the residual butanal is 17 mol % or less, based on a total amount of butyral group included in the polyvinyl butyral resin after completion of the acetalization reaction and the residual butanal. The conversion rate of the butanal is calculated based on a number of mole.

The polyvinyl butyral resin composition may include the butanoic acid in an amount of 0.01 wt % or less, or more than 0 wt % and 0.01 wt % or less after a washing process.

The detailed description about the function and the amount of the butanoic acid and the polyvinyl alcohol resin and the like are described above, thus further description thereof will be omitted. In addition, the amounts of the residual butanal and the butanoic acid and the like are also described above, thus further description will be omitted.

The film for lamination according to one or more other example embodiments of the present disclosure includes: a lamination layer including i) a polyvinyl butyral resin composition including a polyvinyl butyral resin, a butanoic acid, and 2-ethylhexanoic acid; and ii) a plasticizer.

The lamination layer may include 2-ethylhexanoic acid in an amount of 70 ppm or less; more than 0 ppm to 50 ppm or less; 0.1 ppm to 40 ppm; or 0.1 ppm to 30 ppm. Such a considerably low amount of 2-ethylhexanoic acid means that the amount of the most troublesome substance out of acidic ingredients affecting the quality of a film in a process of manufacturing a film, is remarkably lowered, and this characteristic may enhance the color and durability of the film.

The amount of the butanoic acid in the lamination layer is more than 0 ppm to 70 ppm or less, more than 0 ppm to 50 ppm or less, or 0.1 ppm to 40 ppm.

As described above, the polyvinyl butyral resin composition produced by advancing acetalization reaction in the presence of the butanoic acid can considerably lower the amount of the residual butanal in the polyvinyl butyral resin composition. Additionally, the method may decrease the amount of the reaction by-products derived from the butanal. Particularly, it was experimentally verified that the amount of 2-ethylhexanoic acid, which is an acidic ingredient, may be decreased by the method. This is one important factor, which can prevent the loss of optical properties and mechanical properties of the film for lamination manufactured at relatively high temperature.

The lamination layer may have a yellow index (YI) of 2.7 or less, of 2.5 or less, of 0.1 to 2.5, or of 0.1 to 1.2. Such a yellow index is measured in accordance with ASTM E313 standard. This is thought to be the result of the lowered amount of acidic ingredients in the polyvinyl butyral resin composition, allowing damage of the polyvinyl butyral caused from the acid to be decreased and the yellow index to be lowered.

The lamination layer may have a difference in yellow index before and after an accelerated weathering test (based on 744 hours) by d-YI evaluation, and the difference may be less than 3.

The film for lamination may have a monolayer structure or a multilayer structure.

When the film for lamination is a monolayer structure, the polyvinyl butyral resin described above is applied to the film, and when the film for lamination is a multilayer structure, the polyvinyl butyral resin described above is applied to at least one layer of the film.

The plasticizer may be selected from the group consisting of triethylene glycol bis 2-ethylhexanoate (3G8), tetraethylene glycol diheptanoate (4G7), triethylene glycol bis 2-ethylbutyrate (3GH), triethylene glycol bis 2-heptanoate (3G7), dibutoxyethoxyethyl adipate (DBEA), butyl carbitol adipate (DBEEA), dibutyl sebacate (DBS), bis 2-hexyl adipate (DHA), and mixtures thereof. Specifically, triethylene glycol bis 2-ethylhexanoate (3G8) may be used as the plasticizer.

For example, the film for lamination may have a three-layer structure including a first layer, a second layer, and a third layer. The third layer may be disposed between the first layer and the second layer.

The first layer may include a first polyvinyl acetal in an amount of 60 to 75 parts by weight and a first plasticizer in an amount of 25 to 40 parts by weight, based on a total weight of the first layer. The polyvinyl acetal resin composition described above, in which the amount of the residual butanal has been lowered, may be applied as the polyvinyl acetal resin composition including the first polyvinyl acetal. The plasticizer described above may be applied as the first plasticizer.

The second layer may include a second polyvinyl acetal in an amount of 60 to 75 parts by weight and a second plasticizer in an amount of 25 to 40 parts by weight, based on a total weight of the second layer. The polyvinyl acetal resin composition described above, in which the amount of the residual butanal has been lowered, may be applied as the polyvinyl acetal resin composition including the second polyvinyl acetal. The plasticizer described above may be applied as the second plasticizer.

In this case, the first layer and the second layer can function as a skin layer respectively and has excellent adhesion with transparent laminates such as glass as well as giving excellent mechanical strength to the laminated glass and the like.

The film for lamination may further include a third layer disposed on the first layer and including a third polyvinyl acetal and a third plasticizer.

The third layer may include the third polyvinyl acetal in an amount of 58 to 69 parts by weight and the third plasticizer in an amount of 31 to 42 parts by weight, based on a total weight of the third layer. The polyvinyl acetal resin composition described above, in which the amount of the residual butanal has been lowered, may be applied as the polyvinyl acetal resin composition including the third polyvinyl acetal. The plasticizer described above may be applied as the third plasticizer.

When the film for lamination comprises the third layer, the third layer can function as a sound insulation layer, and the film comprising the third layer can have excellent mechanical strength and excellent insulating performance.

For example, the film for lamination may be a four-layered structure having the first layer-the third layer-the first layer-the second layer, or a five-layered structure having the first layer-the third layer-the second layer-the third layer-the first layer.

The first layer may include the first polyvinyl acetal in an amount of 58 to 80 parts by weight and the first plasticizer in an amount of 20 to 42 parts by weight, based on a total weight of the first layer. The polyvinyl acetal resin composition described above, in which the amount of the residual butanal has been lowered, may be applied as the polyvinyl acetal resin composition including the third polyvinyl acetal. The plasticizer described above may be applied as the first plasticizer. The amount of hydroxyl group in the first polyvinyl acetal may be a value between the amount of hydroxyl group in the first polyvinyl acetal and the amount of hydroxyl group in the second polyvinyl acetal.

In a case of manufacturing a film with four-layered structure or five-layered structure, the film can have an excellent sound insulating quality with wider temperature range, in which delamination can be reduced remarkably by decreasing interlayer heterogeneity.

The film for lamination may have a yellow index of 2.7 or less, of 2.5 or less, of 0.1 to 2.5, or of 0.1 to 1.2. Such a yellow index is measured in accordance with ASTM E313 standard.

The film for lamination having such a yellow index may have excellent properties in transparency and color, and superior durability because the film has considerably low yellow index.

The film for lamination may have a difference in yellow index before and after an accelerated weathering test (based on 744 hours) by d-YI evaluation, and the difference may be less than 3.

For example, the first layer may have a yellow index of 2.7 or less, of 2.5 or less, of 0.1 to 2.5, or of 0.1 to 1.2.

For example, the second layer may have a yellow index of 2.7 or less, of 2.5 or less, of 0.1 to 2.5, or of 0.1 to 1.2.

For example, the third layer may have a yellow index of 2.7 or less, of 2.5 or less, of 0.1 to 2.5, or of 0.1 to 1.2.

The plasticizers applied to each layer of the film may be the same or different.

The film for lamination may further include an additive selected from the group consisting of an antioxidant, a heat stabilizer, a UV absorber, a UV stabilizer, an IR absorber, a glass adhesion regulator, and combinations thereof. The additive may be included in at least one layer within the layers as described above, and due to inclusion of the additive, long-term durability such as thermal stability and light stability, and anti-scattering performance of the film can be enhanced.

A hindered amine-based antioxidant or a hindered phenol-based antioxidant may be used as the antioxidant. Specifically, for the process of manufacturing polyvinyl butyral (PVB), which needs a processing temperature of 150° C. or higher, the hindered phenol-based antioxidant may be used. The hindered phenol-based antioxidant, for example, may be Irganox 1976, 1010, or so, which are available from BASF SE.

A phosphite-based heat stabilizer may be used as the heat stabilizer considering compatibility with an antioxidant. The heat stabilizer, for example, may be Irgafos 168, which is available from BASF SE.

Chemisorb 12, Chemisorb 79, Chemisorb 74, or Chemisorb 102 available from CHEMIPRO KASEI KAISHA, LTD or Tinuvin 328, Tinuvin 329, or Tinuvin 326 available from BASF SE may be used as the UV absorber. Also, Tinuvin available from BASF SE may be used as the UV stabilizer.

ITO, ATO, and AZO may be used as the IR absorber, and a salt of a metal such as magnesium (Mg), potassium (K), sodium (Na), epoxy-based modified silicon (Si) oil, or a mixture thereof may be used, as the glass adhesion regulator, but the present disclosure is not limited thereto.

The film may have a total thickness of 0.4 mm or more, for example, of 0.4 to 1.6 mm, of 0.5 to 1.2 mm, or 0.6 to 0.9 mm. The range of the thickness may be selected considering meeting performance requirements while minimizing cost.

The film may consist of the first layer, or may include the first layer.

A thickness of the third layer included in the film may be 0.04 to 0.20 mm, 0.07 to 0.18 mm, or 0.09 to 0.15 mm.

A thickness of the first layer included in the film may be 0.1 mm or less, 0.09 mm or less, 0.001 to 0.1 mm, 0.001 to 0.08 mm, or 0.001 to 0.3 mm.

The film may include a third layer, and may have a loss coefficient of 0.35 or more measured under the temperature condition of 20° C. and the frequency condition of 2,000 to 4,000 Hz.

A laminated glass according to one or more other example embodiments of the present disclosure includes a laminate including: a first glass; the film for lamination described above; and a second glass, wherein the first glass is disposed on one side of the film and the second glass is disposed on the other side of the film.

The first glass and the second glass refer to a platy clear glass, and materials like a light-transmitting plastic may be applicable taking the place of some or all thereof.

The laminated glass may be used for glass in automobiles, interior or exterior materials of architecture, and the like, and may also have a low yellow index and excellent durability.

An automobile according to one or more other example embodiments of the present disclosure includes a laminated glass described above. The laminated glass may be applied as a windshield, for example, as the front glass of the automobile.

Specifically, the automobile includes a body forming the body of the automobile, a driver attached to the body (engine, etc.), a drive wheel attached to be rotatable to the body, a connector connecting the drive wheel and the driver, and a windshield attached to a part of the body, which is a laminated glass shielding wind from outside. The body, the driver, the drive wheel, and the connector may be applied without limit if they are units generally applied to an automobile.

The laminated glass may provide a windshield having impact resistance, penetration resistance, and so on as having excellent optical properties.

Hereinafter, specific example embodiments of the present disclosure will be described in more detail. These specific examples are for illustration only and should not be construed as limiting. In the description of experiment below, “%” refers to wt % in the case where it is uncertain whether wt % or mol % is intended.

1. Producing of Polyvinyl Butyral Resin Compositions

1) Synthesis of PVB Resin Composition (A) Resin (Example)

A polyvinyl alcohol (PVA) of 60 g having a polymerization degree of 1700, and a saponification degree of 99% was thrown into distilled water of 540 g at 90° C., thereby preparing a PVA aqueous solution in an amount of 10 wt %. Subsequently, the PVA aqueous solution was put into a reactor. After the temperature of the reactor was lowered to 17° C., a hydrochloric acid of 36 g having a purity of 37% was injected as a catalyst, and while maintaining the temperature of the reactor at 50 to 55° C., a n-butanal of 33 parts by weight having a purity of 98% and a butanoic acid of 2.5 g were injected, to perform the synthesis of a polyvinyl butyral (PVB).

The temperature of the reactor was lowered to 20° C., and neutralization was carried out for 1 hour by injecting NaOH of 100 g divided in a small portion, thereby obtaining a PVB in a solid state. When the reaction ended, the value of pH was 10.5. The obtained PVB resin composition was washed using distilled water, wherein the amount of distilled water was 10 times that of the PVB resin composition, and washing was repeated six times. Subsequently, the washed PVB resin composition was dried in a warm breeze and in which moisture was eliminated thereby obtaining the PVB resin composition (A) according to the Example as a powder.

2) Synthesis of PVB Resin Composition (B) (Comparative Example)

A polyvinyl alcohol (PVA) of 60 g having a polymerization degree of 1700, and a saponification degree of 99% was thrown into distilled water of 540 g at 90° C., thereby preparing a PVA aqueous solution in an amount of 10 wt %. Subsequently, the PVA aqueous solution was put into a reactor. After the temperature of the reactor was lowered to 17° C., a hydrochloric acid of 36 g having a purity of 37% was injected as a catalyst, and while maintaining the temperature of the reactor at 50 to 55° C., a n-butanal of 33 parts by weight having a purity of 98% was injected in a small portion of 36 g, to perform the synthesis of a polyvinyl butyral (PVB) for 3 hours. Then, a neutralization process, washing, and drying were applied in the same way as the PVB resin composition (A) according to the Example above, thereby obtaining the PVB resin composition (B) according to the Comparative Example.

2. Property Evaluation of Polyvinyl Butyral Resin Compositions

Analysis of the residual amount of a butanoic acid was performed as follows.

After the PVB resin compositions in the state of powder were dissolved in THF (tetrahydrofuran), an ACN (acetonitrile) was added in a small portion. Only substances having a high molecular weight were allowed to be reprecipitated, and only the solution of an upper layer portion was separated, in which substances having a low molecular weight (500 to 2000 amu) had been dissolved. Using the solution as a sample, analysis in accordance with HR LC-MS was performed.

The sample was separated from ACN solution of 10% using C18 column (Hypersil Gold C18) and detected in 210nm using 100% ACN as an eluting solution after 9 minutes. Then, the sample was ionized by ESI mode at 320° C., and the ingredients thereof were checked with MS/MS method, thereby confirming a butanoic acid detected around RT 0.964.

For quantitative analysis of a butanoic acid, the samples were prepared, to which a butanoic acid was added in the amounts of 50ppm, 100ppm, and 300ppm, respectively. And the samples were measured in the same condition as above, thereby making a calibration curve, such that the butanoic acid detected in the resin composition was quantified, respectively.

If the residual amount of the butanoic acid was 0.01wt % or less, it was designated as Pass. If the residual amount of the butanoic acid was more than 0.01wt %, it was designated as Fail.

Characteristics and the like of the reaction composition and the synthesized polyvinyl butyral resin composition are listed in Table 1 and Table 2 below, respectively.

TABLE 1

| | | | | Amount | | | Mole of | Mole |
|---|---|---|---|---|---|---|---|---|
| (Parts by | Distilled | | Concentration | of n- | Additive | | n- | of |
| Weight) | Water | PVA | of Solution | Butanal | Type | Amount | Butanal¹⁾ | PVA²⁾ |
| Resin | 540 | 60 | 10.00% | 33 | Butanoic | 2.5 | 0.448 | 1.349 |
| Composition | | | | | Acid | | | |
| A | | | | | | | | |
| (Example) | | | | | | | | |
| Resin | 540 | 60 | 10.00% | 36 | — | — | 0.489 | 1.349 |
| Composition | | | | | | | | |
| B | | | | | | | | |
| (Comparative | | | | | | | | |
| Example) | | | | | | | | |

¹⁾Mole of n-Butanal = Weight of added n-Butanal * Purity of n-Butanal/Molecular weight of n-Butanal. Molecular weight of n-Butanal: 72.11 g/mol, Purity of 98%.
²⁾Mole of PVA = Weight of added PVA/Molar Mass of PVA. Molar Mass of PVA (Saponification Degree of 99%): 44.4702 g/mol.

TABLE 2

| | Characteristics of Polyvinyl Butyral Resin Composition (mol %) | | | | | | | | |
|---|---|---|---|---|---|---|---|---|---|
| | | | | | | | | Amount | |
| | | | | Amount of | | | | of | |
| | | | | Butyral | | | | Residual | Residual |
| | | | | in PVB | | | | Butyral | Amount |
| | | | | resin | Conversion | Amount | Difference | after | of |
| | | | | When | Rate | of | of | Conversion | Butanoic |
| | | | | Synthesized | to | Unreacted | Unreacted | (mol, | acid in |
| | Butyral | Hydroxyl | Acetyl | in | Butyral | Butyral | Butanal | Calculated | Resin |
| | Group | Group | Group | 100 %³⁾ | (%) ⁴⁾ | (mol %) ⁵⁾ | (mol%)⁶⁾ | Value)⁷⁾ | Composition |
| Resin | 54.9 | 44.3 | 0.8 | 66.5 | 82.6 | 11.6 | 5.7 | 0.052 | Pass |
| Composition | | | | | | | | | |
| A | | | | | | | | | |
| (Example) | | | | | | | | | |
| Resin | 55.2 | 44 | 0.8 | 72.5 | 76.1 | 17.3 | — | 0.085 | N/A⁸⁾ |
| Composition | | | | | | | | | |
| B | | | | | | | | | |
| (Comparative | | | | | | | | | |
| Example) | | | | | | | | | |

³⁾Amount of Butyral in PVB resin When Synthesized in 100% is a stoichiometric value of butyral groups in the polyvinyl butyral resin when all of the added n-butanal in the reaction composition is reacted thereby generating PVB, and calculated by Equation (1) below. Equation (1) Content of Butyral inside PVB resin When Synthesized in 100% (mol %) = Mole of n-Butanal/(Mole of PVA/2) * 100.
⁴⁾ Conversion Rate to Butyral (%) = Amount of Generated Butyral/(Amount of Butyral in PVB resin When Synthesized in 100 %) * 100.
⁵⁾ Amount of Unreacted Butyral (mol %) = Amount of Butyral in PVB resin When Synthesized in 100% [mol %]-Amount of Butyral Group in Polyvinyl Butyral Resin [mol %]
⁶⁾Difference between the Case in which Butanoic acid Is Applied and the Case in which Butanoic acid Is Not Applied (%) = (Amount of Residual Butyral after Conversion When Butanoic acid Is Not Applied)-(Amount of Residual Butyral after Conversion When Butanoic acid Is Applied).
⁷⁾Amount of Residual Butyral after Conversion = Mole of Butanal in the Reaction Composition *Amount of Unreacted Butyral/100
⁸⁾Not evaluated since Butanoic acid is not included in the Reaction Composition.

Referring to Table 1 and Table 2 above, it can be verified that, when a butanoic acid is applied, the conversion rate to butyral is enhanced and butanoic acid applied as an additive is eliminated easily in a process of washing. In addition, a considerable difference in the amount of an unreacted butanal (%) is also verified between the case in which a butanoic acid is applied and the case in which a butanoic acid is not applied. Compared with the Comparative Example, where a butanoic acid is not applied, the amount of the residual butanal in the Example, where a butanoic acid is applied, decreased by about 5.7% (based on the number of moles, 17.3-11.6).

3. Manufacture of a Film for Lamination

1) Preparation of an Additive Mixture

Irganox1010 and Irganox168 in an amount of 0.1 parts by weight respectively, Tinuvin P in an amount of 0.3 parts by weight, potassium acetate (K Ac) in an amount of 0.022 parts by weight, and magnesium acetate (Mg Ac) in an amount of 0.028 parts by weight were mixed, thereby preparing an additive mixture of 0.55 parts by weight.

2) Manufacture of a Film for Lamination (Example)

Polyvinyl butyral resin composition (A) of 72.45 parts by weight, 3G8 as a plasticizer in an amount of 27 parts by weight, and the additive mixture of 0.55 parts by weight, were added into a twin-crew extruder, and the film for lamination having a total thickness of 780 μm according to the Example was manufactured using a T-die.

3) Manufacture of a Film for Lamination (Comparative Example)

Polyvinyl butyral resin composition (B) of 72.45 parts by weight, 3G8 as a plasticizer in an amount of 27 parts by weight, and the additive mixture of 0.55 parts by weight, were added into a twin-crew extruder, and the film for lamination having a total thickness of 780 μm according to the Comparative Example was manufactured using a T-die.

4. Property Evaluation of the Film for Lamination

1) Analysis for Residual Amount of Butanoic acid in the Film for Lamination

After the manufactured PVB film was dissolved in THF (tetrahydrofuran), an ACN (acetonitrile) was added in a small portion. Only substances having a high molecular weight were allowed to be reprecipitated, and only the solution of an upper layer portion was separated, in which substance having a low molecular weight (500 to 2000 amu) had been dissolved. Using the solution as a sample, analysis in accordance with HR LC-MS was performed.

The sample was separated from ACN solution of 10% using C18 column (Hypersil Gold C18) and detected in 210nm using 100% ACN as an eluting solution after 9 minutes. Then, the sample was ionized by ESI mode at 320° C., and the ingredients thereof were checked with MS/MS method, thereby confirming a butanoic acid detected around RT 0.964.

For quantitative analysis of a butanoic acid, the samples were prepared, to which a butanoic acid was added in the amounts of 50 ppm, 100 ppm, and 300 ppm, respectively. And the samples were measured in the same condition as above, thereby making a calibration curve, such that the butanoic acid detected in the resin composition was quantified, respectively.

In Table 3 below, if the residual amount of beta/gamma-butanoic acid was 70 ppm or less, it was designated as Pass, and if the residual amount of the butanoic acid was more than 70 ppm, it was designated as Fail.

2) Analysis of Residual Amount of 2-Ethylhexanoic Acid in the Film for Lamination

Reaction by-products derived from butanal in the film for lamination were analyzed using TD-GC/MS (Thermal Desorption-Gas Chromatograph/Mass Spectrometer).

Each 0.5 g from the films manufactured according to the Example and the Comparative Example were taken respectively, and allowed to pass a first heating detaching unit and a second heating detaching unit located inside TD (JTD-505III available from JAI).

The temperatures were 150° C. (PAT) and −40° C. (cold trap), PAT heating time was 15 minutes, and SAT detaching time was 3 minutes. Split ratio was 1/50.

The samples passing the TD were separated and detected through GC-MS. Specifically, 7890B (GC) and 5977A (MS) having HPSMS column (0.25 mm×30 m×0.25 μm) and available from AGILENT were used for the experiment, under the condition of Oven: 40° C. (5 min holding)—10° C./min-280° C. (5 min holding)—10° C./min-300° C. (9 min holding).

2-ethyl-hexanol (RT12.49) and 2-ethyl-hexanoic acid (RT14.14), which are target substances, detected at the time between 12 minutes and 15 minutes were quantitatively analyzed with FID detector.

For quantitative analysis, standard samples in which 2-ethyl-1-hexanol was dissolved were prepared with three concentrations as follows—439 ppm, 1131 ppm, and 2695 ppm, and analysis thereof was carried out. After calibration curve was made with input quantity as the y-axis and peak area as the x-axis, the residual amount of 2-ethylhexanoic acid was confirmed by performing relative quantification with respect to the two types of the target substances above.

3) YI Evaluation (Yellow Index Evaluation)

The yellow index (Y.I) of the film for lamination was measured in accordance with ASTM E313.

Specifically, samples were prepared by laminating through heating and pressing for 10 minutes at 150° C. in a laminator with a laminated structure of release film-sheet-release film (silicon coating PET). After the release films were removed from the samples, the samples were measured under the condition of D65 and 10 degree, using UltraScan Pro available from HUNTER LAB, and the results are shown in Table 3 below.

4) d-YI Evaluation Method

An accelerated weathering test of the laminated glass was carried out in accordance with KS M ISO 4892-3:2002 and the durability was evaluated based on d-YI (difference in yellow index).

Glass having a dimension of 70 mm×150 mm and a thickness of 2.1 mm and the films for lamination manufactured as above according to the Example and the Comparative Example were applied respectively, thereby preparing laminated structures of glass-film-glass, and pre-lamination and main lamination thereof were performed. The initial value of yellow index (YIᵢₙᵢₜᵢₐₗ) in the center of the samples in a state of being laminated was measured using a measuring apparatus available from HUNTER LAB in accordance with ASTM E313 standard.

Samples of which the initial value had been measured were put into QUV apparatus and an accelerated weathering test thereof was performed for 744 hours. After the test, the final value of yellow index (YI_{final}) in the center of samples was measured and the difference in yellow index was calculated by Equation (3) as follows:

d−YI=YI_{final}−YIᵢₙᵢₜᵢₐₗ (3)

Calculated d−YI was sorted as Fail, if it was greater than 3, and was sorted as Pass if it was smaller than 3. The result is shown in Table 3 below.

5) Penetration Resistance Evaluation of the Sheet

Penetration resistance of laminated glass was evaluated in accordance with KS L 2007.

Glass having a dimension of 300 mm×300 mm and a thickness of 2.1 mm and the film according the Example, and the film according to the Comparative Example were applied respectively, thereby preparing laminated structures of glass-film-glass. Pre-laminating in vacuum, deaeration, and edge sealing were performed for the structures. Subsequently, samples were prepared by main laminating at 150° C. for 2 hours using an autoclave. Then, a hard ball of 2.26 kg was dropped on the samples, and the heights, where the samples were penetrated by the ball (MBH), were measured. If the sample was penetrated by the ball in a height less than 4 m, it was designated as Fail, and if the sample was penetrated by the ball in a height of 4 m or higher, it was designated as Pass.

6) Impact Resistance Evaluation of the Sheet

Whether laminated glass was collapsing when impact resistance evaluated in accordance with KS L 2007:2008 was evaluated.

The process of laminating glass with a thickness of 2.1 mm and the films according the Example and the Comparative Example respectively and the process of preparing a laminated structure of glass-film-glass were carried out in the same way with the penetration resistance evaluation as described above.

As a low temperature evaluation, a hard ball of 227 g was dropped from a height of 9 m after the ball had been kept for 4 hours at minus 20° C. The sample was designated as Fail, if the sample impacted by the hard ball was broken and scattered, or the amount of glass fragments detached from the sample was 15 g or more. The sample was designated as Pass, if the sample impacted by the hard ball was not broken or scattered, or the amount of glass fragments detached from the sample was less than 15 g.

As a room temperature test, a hard ball of 227 g was dropped from a height of 10 m after the ball had been kept for 4 hours at 40° C. The sample was designated as Fail, if the sample impacted by the hard ball was broken and scattered, or the amount of glass fragments detached from the sample was 15 g or more. The sample was designated as Pass, if the sample impacted by the hard ball was not broken or scattered, or the amount of glass fragments detached from the sample was less than 15 g.

TABLE 3

| | | Com- |
|---|---|---|
| | | parative |
| Items for Evaluation | Example | Example |
| Residual Amount of Butanoic acid in the Film | Pass | N/A* |
| Residual Amount of 2-Ethylhexanoic Acid in | 30 | 99 |
| the Film (ppm)** | | |
| Color of the Film (Yi) | 1.1 | 3.5 |
| Durability of the Film (d-YI) | Pass | Fail |
| Penetration Resistance | pass | pass |
| Impact Resistance (Low Temperature) | pass | pass |
| Impact Resistance (Room Temperature) | pass | pass |

*Not evaluated since Butanoic acid is not included in the Reaction Composition.
**ppm was evaluated by the method described as above based on weight.

Referring to the Table 3 above, the Example, where the amount of 2-ethylhexanoic acid was low in the composition after the reaction, shows excellent color or durability of the film compared to the Comparative Example. In addition, penetration resistance and impact resistance were also excellent.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of producing a polyvinyl butyral resin composition comprising:
preparing a reaction composition comprising i) a polyvinyl alcohol resin, ii) a butanal, and iii) a butanoic acid; and
obtaining the polyvinyl butyral resin composition,
wherein a conversion rate of butanal is 77% or more, and
wherein the conversion rate of butanal is calculated according to Formula 1:
Conversion rate of butanal (mole %)=actual mole number of butyral groups in the polyvinyl butyral resin/stoichiometric mole number of butyral groups in the polyvinyl butyral resin when all of the butanal in the reaction composition is reacted*100. (1)

2. The method of producing a polyvinyl butyral resin composition of claim 1, wherein the polyvinyl butyral resin in the polyvinyl butyral resin composition is formed by an acetalization reaction of the reaction composition.

3. The method of producing a polyvinyl butyral resin composition of claim 1, wherein the preparing the reaction composition comprises preparing a polyvinyl alcohol resin solution and adding the butanal and the butanoic acid to the polyvinyl alcohol solution.

4. The method of producing a polyvinyl butyral resin composition of claim 1, wherein the reaction composition comprises the butanoic acid in an amount of 0.1 to 5 parts by weight based on the butanal in an amount of 10 parts by weight in the reaction composition.

5. The method of producing a polyvinyl butyral resin composition of claim 1, wherein the polyvinyl butyral resin composition comprises the residual butanal in an amount of 17 mol % or less based on the butanal comprised in the reaction composition.

6. The method of producing a polyvinyl butyral resin composition of claim 1, further comprising:
neutralizing the polyvinyl butyral resin composition;
washing the neutralized polyvinyl butyral resin composition one or more times; and
drying the washed polyvinyl butyral resin composition.

7. The method of producing a polyvinyl butyral resin composition of claim 6, wherein the washing is performed with a washing solution having a weight ratio of 5 to 10 with respect to a weight of the polyvinyl butyral resin in the polyvinyl butyral resin composition.

8. The method of producing a polyvinyl butyral resin composition of claim 6, wherein the polyvinyl butyral resin composition after the washing comprises the residual butanoic acid in an amount of 0.01 wt % or less based on a total weight of the polyvinyl butyral resin composition.

9. The method of producing a polyvinyl butyral resin composition of claim 1, wherein the method decreases an amount of an unreacted butanal by 5 mol % or more compared to a method of producing polyvinyl butyral resin composition using a reaction composition not comprising a butanoic acid.

10. A film for lamination comprising a lamination layer comprising:
a polyvinyl butyral resin composition comprising a polyvinyl butyral resin, a butanoic acid, and 2-ethylhexanoic acid; and
a plasticizer.

11. The film of claim 10, wherein an amount of the butanoic acid in the lamination layer is more than 0 ppm, and 70 ppm or less based on a total weight of the lamination layer.

12. The film of claim 10, wherein an amount of the 2-ethylhexanoic acid in the lamination layer is more than 0 ppm, and 70 ppm or less based on a total weight of the lamination layer.

13. The film of claim 10, wherein the lamination layer has a yellow index of 2.7 or less.

14. The film of claim 10, wherein the polyvinyl butyral resin in the polyvinyl butyral resin composition is formed by an acetalization reaction of the reaction composition comprising a polyvinyl acetal resin, a butanal, and a butanoic acid.

15. The film of claim 10, wherein the film comprises:
a first layer comprising a first polyvinyl acetal and a first plasticizer;
a second layer comprising a second polyvinyl acetal and a second plasticizer and disposed on the first layer; and
a third layer comprising a third polyvinyl acetal and a third plasticizer and disposed between the first layer and the second layer.

16. The film of claim 15, wherein the first layer comprises the first polyvinyl acetal in an amount of 60 to 75 parts by weight and the first plasticizer in an amount of 25 to 40 parts by weight, based on a total weight of the first layer.

17. The film of claim 15, wherein the second layer comprises the second polyvinyl acetal in an amount of 60 to 75 parts by weight and the second plasticizer in an amount of 25 to 40 parts by weight, based on a total weight of the second layer.

18. The film of claim 15, wherein the third layer comprises the third polyvinyl acetal in an amount of 58 to 69 parts by weight and the third plasticizer in an amount of 31 to 42 parts by weight, based on a total weight of the third layer.

19. The film of claim 15, wherein an amount of a third hydroxyl group in the third polyvinyl acetal is lower than an amount of a first hydroxyl group in the first polyvinyl acetal or an amount of a second hydroxyl group in the second polyvinyl acetal.

20. A laminated glass comprising a laminate comprising:
a first glass;
the film of claim 10; and
a second glass,
wherein the first glass is disposed on one side of the film and the second glass is disposed on the other side of the film.
